(19) United States
(12) Patent Application Publication
(10) Pub. No.: US 2026/0042074 A1
(43) Pub. Date: Feb. 12, 2026

(54) STAND MIXER ORBITAL ASSEMBLY

(71) Applicant: Haier US Appliance Solutions, Inc., Wilmington, DE (US)

(72) Inventors: Danister Abeygunawardana, Jeffersonville, IN (US); Tomas Garces, Louisville, KY (US); Joshua Thomas, New Salisbury, IN (US); Ruochong Song, Louisville, KY (US)

(21) Appl. No.: 18/797,750

(22) Filed: Aug. 8, 2024

(51) Int. Cl. B01F 35/31; A47J 43/044; A47J 43/08; B01F 101/00; F16D 1/06; F16D 1/10

(52) U.S. Cl. CPC B01F 35/31; A47J 43/044; A47J 43/082; F16D 1/06; F16D 1/10; A47J 2043/04454; B01F 2101/1805

(57) ABSTRACT

A stand mixer comprises a base and a support column coupled to the base and extending upwardly from the base. The stand mixer further includes a head coupled to an upper end of the support column and extending from the support column above the base. The stand mixer further includes an orbital assembly. The orbital assembly comprises an orbital cover coupled with the head. The orbital cover defines a keyed aperture. The orbital assembly further includes a Keyed shaft coupled with the head and extending through the Keyed aperture of the orbital cover. The orbital assembly comprises a screw mount that comprises an axial boss coupled with the keyed shaft at the keyed aperture and a head portion coupled with the axial boss.

### FIELD OF THE INVENTION

The present disclosure relates generally to stand mixers, or more specifically, to the orbital coupling assembly of a stand mixer.

### BACKGROUND OF THE INVENTION

Stand mixers are generally used for performing automated mixing, churning, or kneading involved in food preparation. Typically, stand mixers include a motor configured to provide torque to one or more driveshafts. Users may connect various utensils to the one or more driveshafts, including whisks, spatulas, or the like. Various driveshaft coupling assemblies have been developed to couple the driveshaft to the stand mixer to permit use of the utensils. The driveshaft coupling assemblies may utilize small pins that can easily get lost during maintenance. Some stand mixers may even leak oil or grease from the driveshaft into the mixing bowl. Accordingly, further improvements are needed.

Accordingly, a stand mixer having an improved orbital assembly would be desirable. More specifically, an orbital assembly that is capable of sealing the driveshaft within the stand mixer would be desirable.

### BRIEF DESCRIPTION OF THE INVENTION

Aspects and advantages of the invention will be set forth in part in the following description, or may be apparent from the description, or may be learned through practice of the invention.

In one example aspect, a stand mixer comprises a base and a support column coupled to the base and extending upwardly from the base. The stand mixer further includes a head coupled to an upper end of the support column and extending from the support column above the base. The stand mixer further includes an orbital assembly. The orbital assembly comprises an orbital cover coupled with the head. The orbital cover defines a keyed aperture. The orbital assembly further includes a keyed shaft coupled with the head and extending through the keyed aperture of the orbital cover. The orbital assembly comprises a screw mount that comprises an axial boss coupled with the keyed shaft at the keyed aperture and a head portion coupled with the axial boss.

In another example aspect, an orbital assembly is for a stand mixer. The stand mixer includes a base, a support column coupled to the base that extends upwardly from the base. The stand mixer includes a head coupled to an upper end of the support column and extending from the support column above the base. The orbital assembly includes an orbital cover coupled with the head, the orbital cover defines a first aperture and a keyed aperture. The orbital assembly includes a keyed shaft coupled with the head and extending through the keyed aperture. The orbital assembly also includes a screw mount that includes an axial boss coupled with the keyed shaft and a head portion coupled with the axial boss.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an example embodiment of a stand mixer of the present disclosure.

FIG. 2 is a cross-sectional view of an example embodiment of an orbital assembly taken along the line A-A of the example stand mixer of FIG. 1.

FIG. 3 is an exploded view of the example orbital assembly of FIG. 2.

FIG. 4 is a bottom perspective view of the example orbital assembly of FIG. 2.

FIG. 5 is a front cross-sectional view taken along the line B-B of the example stand mixer of FIG. 1.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

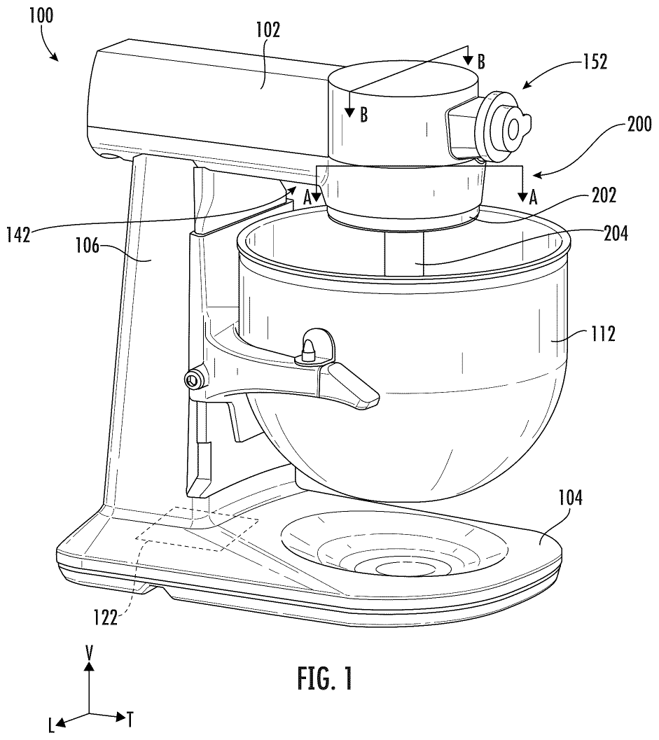

FIG. 1 provides a perspective view of a stand mixer 100 according to an example embodiment of the present subject matter. It will be understood that stand mixer 100 is provided by way of example only and that the present subject matter may be used in or with any suitable stand mixer in alternative example embodiments. Moreover, with reference to FIG. 1, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

Stand mixer 100 may include a base 104 and a support post or column 106. Support column 106 may support a mixer head 102, which is positioned atop column 106. Mixer head 102 may house a motor 130, a gearbox 132, and/or a drivetrain apparatus 134 of stand mixer 100. For example, as shown in FIG. 1, head 102 may be mounted to column 106, which is mounted to mixer base 104. Thus, column 106 may extend between and connect mixer base 104 and head 102, e.g., along the vertical direction V. Head 102 may extend outwardly above the mixer base 104, e.g., in the transverse direction T.

Furthermore, the stand mixer 100 includes an orbital assembly 200. The orbital assembly 200 is located on a lower portion or underside 142 of head 102 and forward of support column 106 along transverse direction T. The orbital assembly 200 includes an orbital cover 202 coupled with the head 102. A quick chuck 204 is coupled to the head 102 and extends through the orbital cover 202. In certain embodiments, the quick chuck 204 may couple with a mixing attachment for mixing contents within a bowl 112. Additionally, or alternatively, more than one type of mixing attachment may couple with the quick chuck 204. Various types of mixing attachments may be used including e.g., whisks, paddles, dough hooks, beaters, and others for purposes of mixing ingredients within the bowl 112 or another container supported by the mixer base 104. During use, rotation of the quick chuck 204 may be driven in a circular, orbital, or planetary manner in either a rotational clockwise direction CW and/or a rotational counterclockwise direction CCW directionally opposite clockwise direction CW. Spinning in a planetary manner, as used herein, includes spinning both in a circular manner and orbiting about an axis A that moves in an arcuate manner.

Example operation of an exemplary embodiment of the stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on a motor to begin the process of mixing, kneading, beating, etc. The motor rotates an attachment attached to stand mixer 100 to complete each of these processes. The processes may be conducted with a respective attachment such as a mixer blade for mixing, a dough hook for kneading, and a balloon whisk for beating.

Furthermore, in some embodiments, head 102 includes an auxiliary attachment support located on a forward portion or frontside 152 of head 102 in the transverse direction T and forward of support column 106 in the transverse direction T. An auxiliary attachment assembly (not shown), such as a pasta attachment, may be removably coupled to the auxiliary attachment support.

Referring now to FIGS. 1 through 5, the orbital assembly 200 that may be used with stand mixer 100 for removably coupling a driveshaft 240 with the stand mixer 100 will be described according to example embodiments of the present subject matter.

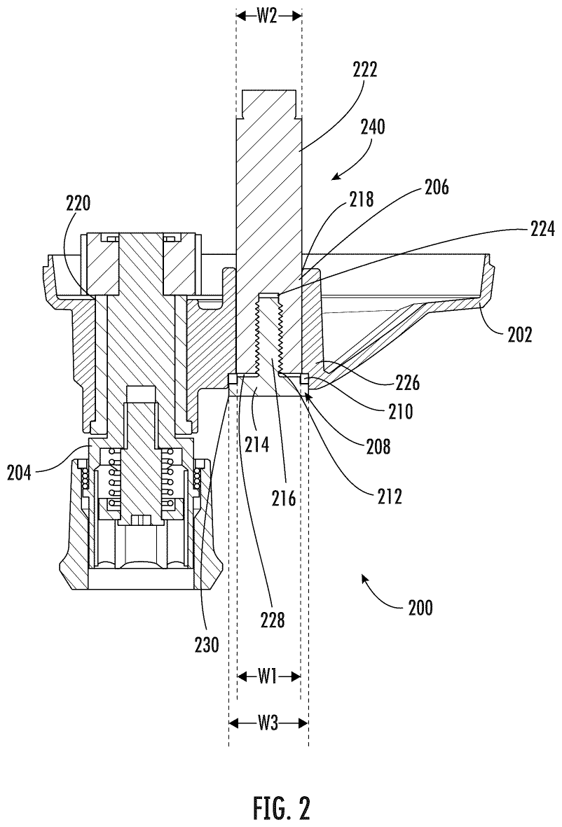

With specific reference to FIG. 2 the driveshaft assembly 240 includes a keyed shaft 206, that may also be referred to as a D-shaped shaft, and a cylindrical portion 222 coupled with the keyed shaft 206. The orbital cover 202 defines a keyed aperture 218, that may also be referred to as a D-shaped aperture. The keyed shaft 206 extends through the keyed aperture 218. The keyed shaft 206 may be sized and shaped such that the keyed shaft 206 remains in contact with the orbital cover 202 within the keyed aperture 218 (e.g., a flush or snug fit). The relationship between the driveshaft assembly 240 and the orbital cover 202 is further described below. The driveshaft assembly 240 may be made from a metallic, polymeric, or other suitable material that can withstand torsion.

The keyed shaft 206 defines a threaded aperture 224. The threaded aperture 224 may be centrally located along an axis A of the driveshaft assembly 240. Thus, the threaded aperture 224 may not be centrally, axially located within the keyed shaft 206. The threaded aperture 224 may be threaded such that the threaded aperture 224 receives via a twisting motion. Alternatively, or additional, the threaded aperture 224 may be threaded such that the threaded aperture 224 receives via a pushing motion (e.g., barbs).

The orbital assembly 200 further includes a screw mount 208. The screw mount 208 may have a side profile, as illustrated, that resembles an upside-down T. The screw mount 208 comprises an axial boss 216 and a head portion 214 coupled with the axial boss 216. The threaded aperture 224 of the keyed shaft 206 is configured to receive the axial boss 216 of the screw mount 208. For example, the axial boss 216 may be twisted into the threaded aperture 224. The head portion 214 may include a first shoulder 228 and a second shoulder 230 coupled with the first shoulder 228. The first shoulder 228 may have a first width W1. The drive shaft assembly 240 may have a second width W2. The first width W1 and the second width W2 may be about equal. The second shoulder 230 may have a third width W3 that is greater than the first width W1.

The orbital cover 202 may include a third shoulder 226 that surrounds the periphery of the D shaped aperture 218. The orbital assembly 200 may include a gasket 210. The gasket 210 may be disposed between the second shoulder 230 of the head portion 214 and the third shoulder 226 of the orbital cover 202. The gasket 210 and the second shoulder 230 may prevent the screw mount 208 from overextending into the keyed aperture 218. Additionally, or alternatively, the gasket 210 and the second shoulder 230 may seal any liquids and gases from leaving the keyed aperture 218.

The orbital assembly 200 may further include a spring 212. The spring may circumferentially surround the axial boss 216 of the screw mount 208. Therefore, the spring may engage with the keyed shaft 206 and the first shoulder 228 of the head portion 214 of the screw mount 208. The spring 212 may bias the screw mount 208 away from the keyed shaft 206. Biasing the screw mount 208 axially away from the keyed shaft 206 allows for greater friction between the D shaped shaft 206 and the axial boss 216 within the threaded aperture 218.

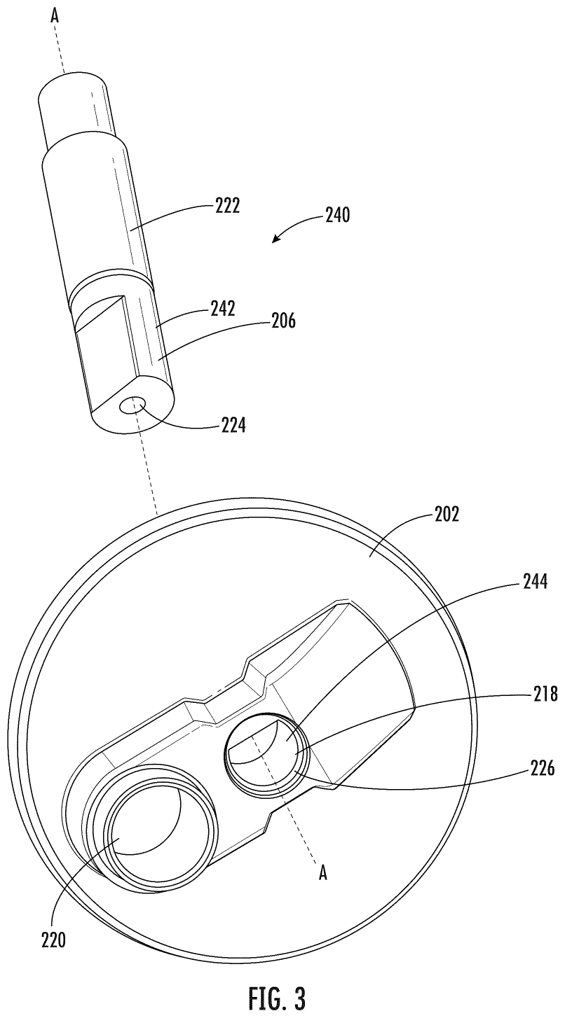

With specific reference to FIG. 3, the drive shaft assembly 240 is aligned with the axis A. Furthermore, the keyed aperture 218 of the orbital cover 202 is aligned with the keyed shaft 206 of the driveshaft assembly 240. The third shoulder 226 is actually aligned with the axis A. The cylindrical portion 222 engages with the orbital cover 202 at the D-shaped aperture, keyed aperture 218 opposite the third shoulder 226.

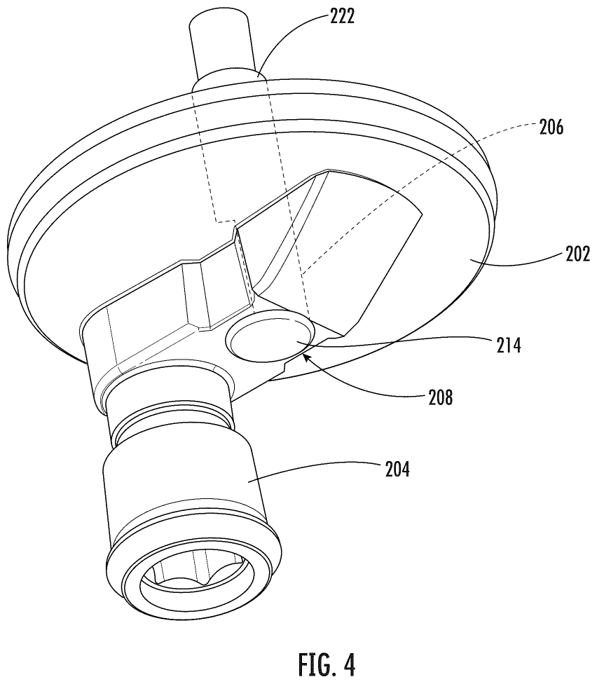

With reference to FIG. 4, from a user perspective the keyed shaft 206, the axial boss 216, the first shoulder 228, the spring 212, the gasket 210, and the keyed aperture 218 may be obstructed from view by the second shoulder 230 of the head portion 214.

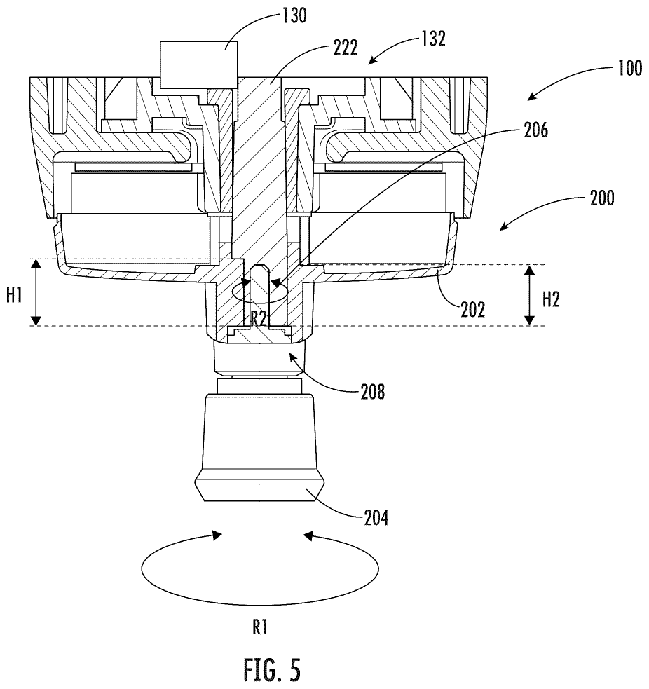

With reference to FIG. 5, the keyed shaft 206 has a first height H1. The axial boss 216 has a second height H2 that may be about equal to H1. Additionally, or alternatively, H2 maybe less than H1. Additionally, or alternatively, H2 may be greater than H1.

With further reference to FIG. 5, the mixer head 102 may house a motor 130, a gearbox 132, and/or a drivetrain apparatus 134 of the stand mixer 100. The driveshaft assembly 240 connects with a motor 130 and a gearbox 132 such that the motor 130 may drive rotation of the driveshaft assembly 240. The gearbox 132 may allow a user selection of different rotating speeds. The stand mixer 100 may include one or more controls for operations such as selectively powering the motor 130, choosing the speed of rotation. In some embodiments, the motor 130 may be disposed within mixer base 104, including within the column 106.

The motor 130 and the gearbox 132 rotate the driveshaft assembly 240 about the axis A. As a result, the keyed shaft 206 also rotates about the axis A. Because the keyed shaft 206 is engaged with the orbital cover 202 within the keyed aperture 218, the driveshaft assembly 240, rotated by the motor 130 and the gearbox 132, rotates the orbital cover 202 about the axis A. The keyed shaft 206 has an external surface 242. The orbital cover 202 has an internal surface 244 within the keyed aperture 218. The external surface 242 may be engaged with the internal surface 244 allowing for torque to transfer from the driveshaft assembly 240 to the orbital cover 202. Therefore, the quick chuck 204 orbits around the axis A because the motor 130 and the gearbox 132 rotate the driveshaft assembly 240. Further, the gearbox 132 may spin the quick chuck 204.

The motor 130 and the gearbox 132 may rotate the driveshaft assembly 240 a first rotational direction R1 chosen from CW or CCW. The axial boss 216 of the screw mount 208 may twist into the threaded aperture 218 by rotating a second rotational direction R2 that is opposite R1. For example, if the stand mixer 100 is designed and manufactured to rotate the driveshaft assembly 240 CW, the axial boss 216 and the threaded aperture 218 are designed and manufactured to couple via a CCW twisting. Thus, rotating the driveshaft assembly 240, and thus the orbital cover 202, may tighten the screw mount 208 with the keyed shaft 206.

Advantageously, the stand mixer 100 described herein allows for easier maintenance compared to a generic stand mixer that does not utilize the screw mount 208 and the keyed shaft 206. Further, the driveshaft assembly 240 remains static relative to the orbital cover 202, which can prevent unnecessary grinding between parts. Even further, the screw mount 208 and the gasket 210 may keep lubricants inside the keyed aperture 218. The stand mixer 100 described herein offers an elegant way to use and maintain such an appliance.

As explained herein, aspects of the present subject matter are generally directed to a bowl coupling assembly of a stand mixer. The bowl coupling assembly may include a tilt tab and an actuator that is received within an actuator slot for inhibiting rotation of the bowl within the bowl cavity of the mixer base. In this respect, mixing tools of the stand mixer may be used multi-directionally (e.g., in the clockwise and counterclockwise directions) without causing the bowl to rotate within the bowl cavity. Additionally, the tilt tab may include a sloped feature upon which the bowl may be tilted to remove or decouple the bowl from the mixer base of the stand mixer without requiring the bowl to be rotated for decoupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer, comprising:
a base;
a support column coupled to the base and extending upwardly from the base;
a head coupled to an upper end of the support column and extending from the support column above the base; and
an orbital assembly comprising:
an orbital cover coupled with the head, the orbital cover defining a keyed aperture;
a keyed shaft coupled with the head and extending through the keyed aperture of the orbital cover; and
a screw mount comprising:
an axial boss coupled with the keyed shaft at the keyed aperture; and
a head portion coupled with the axial boss.

2. The stand mixer of claim 1, wherein the keyed shaft defines a threaded aperture, and wherein the axial boss of the screw mount is received by the keyed shaft within the threaded aperture.

3. The stand mixer of claim 2, wherein the screw mount is threaded into the threaded aperture a first direction, and wherein the keyed shaft rotates a second direction opposite the first direction.

4. The stand mixer of claim 1, further comprising a gasket disposed between the orbital cover and the screw mount.

5. The stand mixer of claim 4, wherein the head portion of the screw mount comprises:
a first shoulder having a first width that is about equal to a second width of the keyed shaft; and
a second shoulder having a third width that is greater than the first width, wherein the second shoulder engages the gasket.

6. The stand mixer of claim 5, wherein the orbital cover defines a third shoulder around a periphery of the keyed aperture, wherein the third shoulder engages the gasket.

7. The stand mixer of claim 6, wherein the keyed shaft is substantially flush with the third shoulder.

8. The stand mixer of claim 1 further comprising a motor disposed within the head, the motor operably coupled with the keyed shaft.

9. The stand mixer of claim 8, further comprising a quick chuck coupled with the orbital cover, the quick chuck for connecting attachments for mixing, wherein the motor rotates the keyed shaft such that the quick chuck orbits the keyed shaft.

10. The stand mixer of claim 1, wherein the keyed shaft has a first height, and wherein the axial boss has a second height about equal to the first height.

11. The stand mixer of claim 1, wherein the keyed shaft includes a cylindrical portion that partially axially engages the orbital cover.

12. An orbital assembly for a stand mixer, the stand mixer including a base, a support column coupled to the base and extending upwardly from the base, a head coupled to an upper end of the support column and extending from the support column above the base, the orbital assembly comprising:
an orbital cover coupled with the head, the orbital cover defining a first aperture and a keyed aperture;
a keyed shaft coupled with the head and extending through the keyed aperture; and
a screw mount comprising:
an axial boss coupled with the keyed shaft; and
a head portion coupled with the axial boss.

13. The orbital assembly of claim 12, wherein the keyed shaft centrally defines a threaded aperture configured to receive the axial boss of the screw mount.

14. The orbital assembly of claim 12 further comprising a spring engaged with the keyed shaft and the head portion of the screw mount, wherein the spring biases the keyed shaft away from the head portion.

15. The orbital assembly of claim 12 further comprising a gasket engaged with the orbital cover and the head portion of the screw mount.

16. The orbital assembly of claim 12 further comprising a motor disposed within the head of the stand mixer, wherein the motor is operably coupled with the keyed shaft such that the motor in use rotates the keyed shaft.

17. The orbital assembly of claim 16, wherein the keyed shaft rotates the orbital cover around the keyed shaft.

18. The orbital assembly of claim 17, wherein the keyed shaft rotates such that the keyed shaft biases against the orbital cover at the keyed aperture.

19. The orbital assembly of claim 18 further comprising a quick chuck coupled with the orbital cover, the quick chuck for connecting attachments for mixing, wherein the quick chuck orbits around the keyed shaft.

20. The orbital assembly of claim 19, wherein the keyed shaft further comprises a cylindrical portion, wherein the cylindrical portion is operably coupled with the motor.
